(19) United States
(12) Patent Application Publication
(10) Pub. No.: US 2003/0112377 A1
(43) Pub. Date: Jun. 19, 2003

(54) TV tuner unit that is reduced in size

(75) Inventors: Akira Kawamura, Fukushima-ken (JP); Shinichi Yamamoto, Gwangju (KR); Michinori Sasaki, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/322,181

(22) Filed: Dec. 17, 2002

(30) Foreign Application Priority Data
Dec. 19, 2001 (JP) 2001-385700

(51) Int. Cl. H04N 5/50

(52) U.S. Cl. 348/731; 348/733

(57) ABSTRACT

A TV tuner unit is provided with a tuner section for frequency-converting an input TV signal into an intermediate frequency signal, the tuner section having a mixing circuit for frequency conversion, and an oscillation circuit for inputting a local oscillation signal to the mixing circuit; a PLL circuit section for setting a frequency of the local oscillation signal through a tuning voltage by supplying the tuning voltage to the local oscillation circuit; and a video intermediate frequency circuit section for amplifying and detecting the intermediate frequency signal and thereby outputting a video signal and an audio signal, the video intermediate frequency circuit section having at least an intermediate frequency amplification circuit, a video detection circuit, and an audio detection circuit. The mixing circuit, an oscillation transistor circuit that is part of the oscillation circuit, the PLL circuit section, the intermediate frequency amplification circuit, the video detection circuit, and the audio detection circuit are provided in a single IC.

### BACKGROUND OF THE INVENTION

1. Field of the Invention

The present invention relates to a TV tuner unit having a tuner section for frequency-converting a received TV signal into an intermediate frequency signal, a PLL circuit section for controlling a local oscillation signal of the tuner section, and a video intermediate frequency circuit section for detecting the intermediate frequency signal and outputting a video signal and an audio signal.

2. Description of the Related Art

First, the circuit configuration of a conventional TV tuner unit (hereinafter referred to simply as “tuner unit”) will be described with reference to FIG. 2. A tuner section 50 is provided with an input tuning circuit 51 for selecting and amplifying a TV signal of a desired channel, a radio-frequency amplification circuit 52, and an inter-stage tuning circuit 53. Each of the input tuning circuit 51 and the inter-stage tuning circuit 53 is provided with a varactor diode (not shown) for varying its tuning frequency. The radio-frequency amplification circuit 52 is a variable gain amplification circuit.

The tuner section 50 is also provided with a mixing circuit 54 for frequency-converting the selected TV signal into an intermediate frequency signal and an oscillation circuit 55. The oscillation circuit 55 is composed of an oscillation transistor circuit 55a and a resonance circuit 55b connected to it. The resonance circuit 55b is also provided with a varactor diode (not shown) which is to vary its resonance frequency.

For reception of channels in a VHF band and a UHF band, the input tuning circuit 51 to the oscillation circuit 55 are provided in two systems (for the VHF band and the UHF band, respectively).

A local oscillation signal for channel selection is supplied from the oscillation circuit 55 to the mixing circuit 54. The frequency of the local oscillation signal is set based on a tuning voltage that is supplied from a PLL circuit section 60 to the varactor diode of the resonance circuit 55b. The tuning voltage is also supplied to the varactor diodes of the input tuning circuit 51 and the inter-stage tuning circuit 53, whereby a tuning frequency is set. Data D for setting the oscillation frequency and the tuning frequency, the local oscillation signal, and a reference frequency signal are input to the PLL circuit section 60. The reference frequency signal is input to the PLL circuit section 60 from a separate oscillator (crystal oscillator). The PLL circuit section 60 is a general-purpose IC (integrated circuit) that is commonly used.

The intermediate frequency signal that is output from the mixing circuit 54 is input to a video intermediate frequency circuit section 70. An intermediate frequency tuning circuit 71, a first-stage intermediate frequency amplification circuit 72, and a SAW filter 73 are provided in this order as input-side circuits of the video intermediate frequency circuit section 70. A video intermediate frequency IC 74 for processing the intermediate frequency signal and outputting a video signal etc. is provided downstream of the SAW filter 73. The IC 74 incorporates an intermediate frequency amplification circuit 74a, a video detection circuit 74b, an audio detection circuit 74c, AGC voltage generation circuits 74d and 74e, a voltage-controlled oscillator 74f, etc. and can be purchased as a general-purpose product. Where the IC 74 is used, an external resonance circuit 75 is connected to the voltage-controlled oscillator 74f.

The second-stage intermediate frequency amplification circuit 74a, which amplifies the intermediate frequency signal together with the first-stage intermediate frequency amplification circuit 72, is a variable-gain amplification circuit. The intermediate frequency signal is subjected to synchronous detection in the video detection circuit 74b and thereby converted into a video signal V by using a local oscillation signal that is input from the voltage-controlled oscillator 74f. The video signal V is input to a circuit of a TV receiver main body (not shown). An audio intermediate frequency signal of 4.5 MHz that has been extracted by the video detection circuit 74b is FM-detected by the audio detection circuit 74c, whereby an audio signal A is extracted. The audio signal A is also input to a circuit of the TV receiver main body.

On the other hand, the video signal V is input to the two AGC voltage generation circuits 74d and 74e in order. An AGC voltage that is output from the first AGC voltage generation circuit 74d is supplied to the second-stage intermediate frequency amplification circuit 74a, and an AGC voltage that is output from the second AGC voltage generation circuit 74e is supplied to the radio-frequency amplification circuit 52.

In the above configuration, only the PLL circuit 60 and the video intermediate frequency IC 74 are ICs. Therefore, the connections between the circuit sections and within each circuit section are complicated, which is an obstacle to miniaturization. More specifically, it is necessary to connect the mixing circuit 54 and the oscillation circuit 55 and to connect the PLL circuit 60 to the oscillation circuit 55. Where each of the mixing circuit 54 and the oscillation circuit 55 are of a balanced type, the connection between them is more complicated. As a result, the efficiency of assembling work cannot be increased.

Further, since no AGC voltage is applied to the first-stage intermediate frequency amplification circuit 72, distortion in the second-stage intermediate frequency amplification circuit 74a becomes problematic as the level of an input TV signal increases. To supply an AGC voltage to the first-stage intermediate frequency amplification circuit 72, additional wiring is necessary because it is not included in the video intermediate frequency IC 74.

### SUMMARY OF THE INVENTION

An object of the present invention is to decrease the number of points where circuits should be connected to each other in manufacturing a tuner unit, to thereby increase the work efficiency and reduce the size of the tuner unit.

The invention provides a TV tuner unit comprising a tuner section for frequency-converting an input TV signal into an intermediate frequency signal, the tuner section comprising a mixing circuit for frequency conversion; and an oscillation circuit for inputting a local oscillation signal to the mixing circuit; a PLL circuit section for setting a frequency of the local oscillation signal through a tuning voltage by supplying the tuning voltage to the local oscillation circuit; and a video intermediate frequency circuit section for amplifying and detecting the intermediate frequency signal and thereby outputting a video signal and an audio signal, the video intermediate frequency circuit section comprising an intermediate frequency amplification circuit, a video detection circuit, and an audio detection circuit, wherein the mixing circuit, an oscillation transistor circuit that is part of the oscillation circuit, the PLL circuit section, the intermediate frequency amplification circuit, the video detection circuit, and the audio detection circuit are provided in a single IC. With this configuration, the number of points where circuits should be connected to each other in manufacturing a tuner unit is decreased, whereby the work efficiency can be increased and the size of the tuner unit can be reduced.

The TV tuner unit may be such that the intermediate frequency amplification circuit includes at least two-stages of cascade-connected amplification circuits; that the TV tuner unit further comprises, outside the IC, a SAW filter that is provided between a first-stage amplification circuit and a second-stage amplification circuit and a resonance circuit that is coupled to the oscillation transistor circuit; and that the IC has a flat package shape having four side faces in which a first side face is provided with a TV signal input terminal through which to input the TV signal to the mixing circuit, a second side face that is opposed to the first side face is provided with an output terminal of the first-stage amplification circuit and an input terminal of the second-stage amplification circuit, a third side face is provided with a resonance circuit connection terminal to which the resonance circuit is connected, and a fourth side face that is opposed to the third side face is provided with an output terminal for the video signal, and output terminal for the audio signal, and a data input terminal through which to input data to be used for setting the tuning voltage to the PLL circuit section. Since the terminals are assigned to the four side faces of the IC based on the frequencies of the external circuits connected to the respective terminals, there does not occur interference between signals.

The TV tuner unit may be such that the intermediate frequency circuit section comprises an AGC voltage generation circuit for generating an AGC voltage corresponding to a level of the TV signal, the AGC voltage generation circuit being provided in the IC; and that the first-stage amplification circuit and the second-stage amplification circuit of the intermediate frequency amplification circuit are variable gain amplification circuits having gain control ends, respectively, that are supplied with the AGC voltage. With this configuration, the AGC voltage can be generated and applied within the IC. Further, since the AGC voltage is also applied to the first-stage amplification circuit, distortion that occurs in each of the amplification circuits downstream of the second-stage amplification circuit can be kept small even if the level of the input TV signal becomes too high.

### BRIEF DESCRIPTION OF THE DRAWINGS

FIG. 1 is a block diagram showing the configuration of a TV tuner unit according to the present invention; and

FIG. 2 is a block diagram showing the configuration of a conventional TV tuner unit.

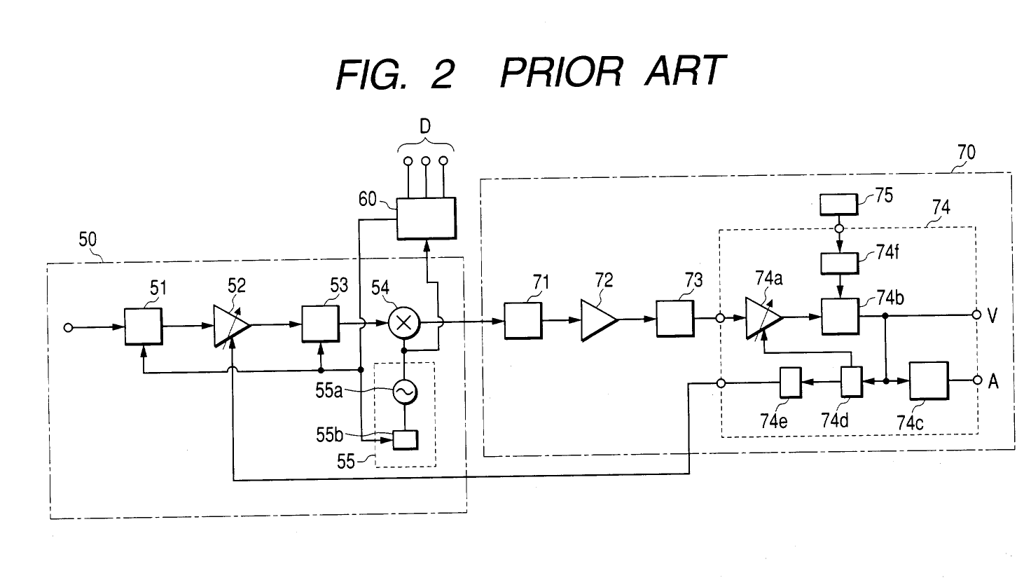

### DESCRIPTION OF THE PREFERRED EMBODIMENTS

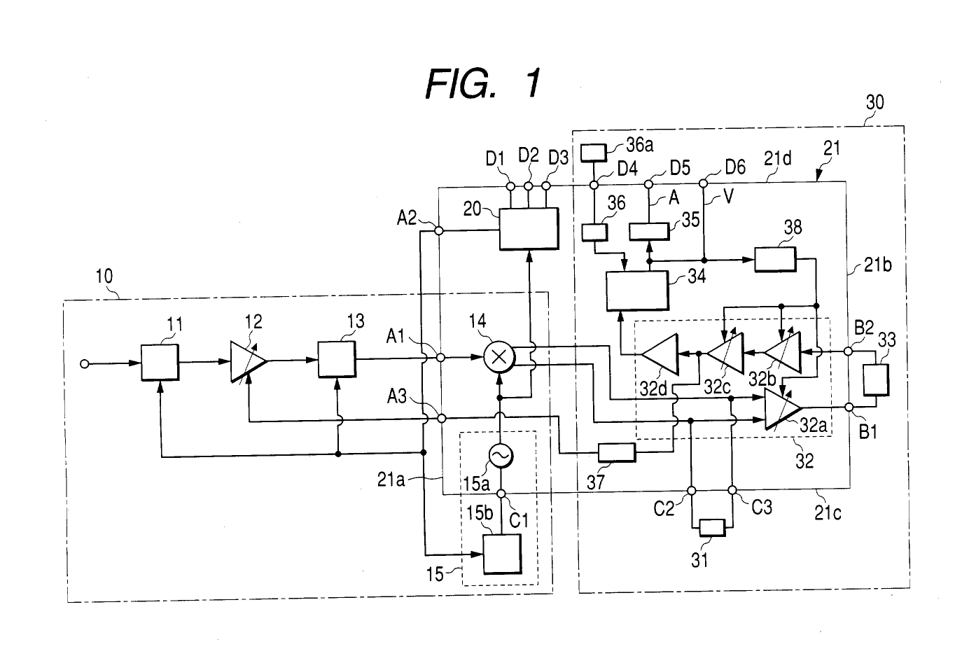

A TV tuner unit according to the present invention will be hereinafter described with reference to FIG. 1. A tuner section 10 is provided with an input tuning circuit 11 for selecting and amplifying a TV signal of a desired channel, a radio-frequency amplification circuit 12, and an inter-stage tuning circuit 13. Each of the input tuning circuit 11 and the inter-stage tuning circuit 13 is provided with a varactor diode (not shown) for varying its tuning frequency. The radio-frequency amplification circuit 12 is a variable gain amplification circuit.

The tuner section 10 is also provided with a mixing circuit 14 for frequency-converting the selected TV signal into an intermediate frequency signal and an oscillation circuit 15. The mixing circuit 14 is of a balanced output type. The oscillation circuit 15 is composed of an oscillation transistor circuit 15a and a resonance circuit 15b connected to it. The resonance circuit 15b is also provided with a varactor diode (not shown) which is to vary its resonance frequency.

For reception of channels in a VHF band and a UHF band, the input tuning circuit 11 to the oscillation circuit 15 are provided in two systems (for the VHF band and the UHF band, respectively).

A local oscillation signal for channel selection is supplied from the oscillation circuit 15 to the mixing circuit 14. The frequency of the local oscillation signal is set based on a tuning voltage that is supplied from a PLL circuit section 20 to the varactor diode of the resonance circuit 15b. The tuning voltage is also supplied to the varactor diodes of the input tuning circuit 11 and the inter-stage tuning circuit 13, whereby a tuning frequency is set. Data D for setting the oscillation frequency and the tuning frequency, the local oscillation signal, and a reference frequency signal Ref are input to the PLL circuit section 20. The reference frequency signal Ref is input to the PLL circuit section 20 from a separate oscillator (crystal oscillator; not shown).

In the above configuration, the mixing circuit 14, the oscillation transistor circuit 15a, and the PLL circuit section 20 are provided in the same tuner IC 21. In the IC 21, to supply the local oscillation signal to the mixing circuit 14 and the PLL circuit section 20, the oscillation transistor circuit 15a is connected to the mixing circuit 14 and the PLL circuit section 20.

The intermediate frequency signal that is output from the mixing circuit 14 is input to a video intermediate frequency circuit section 30. An intermediate frequency tuning circuit 31, an intermediate frequency amplification circuit 32, a SAW filter 33, a video detection circuit 34, an audio detection circuit 35, a voltage-controlled oscillator 36, two AGC voltage generation circuits 37 and 38, etc. The intermediate frequency amplification circuit 32 is a four-stage amplification circuit in which a first stage 32a to a third stage 32c are variable gain amplification circuits and the first-stage amplification circuit 32a is of a balanced input type. Among the above circuits, the intermediate frequency amplification circuit 32, the video detection circuit 34, the audio detection circuit 35, the voltage-controlled oscillator 36, and the two AGC voltage generation circuits 37 and 38 are provided in the IC 21.

The balanced input ends of the first-stage amplification circuit 32a are connected to the balanced output ends of the mixing circuit 14, and the intermediate frequency tuning circuit 31 is provided between the two balanced lines. However, the intermediate frequency tuning circuit 31 is provided outside the IC 21. The SAW filter 33 is provided between the first-stage amplification circuit 32a and the second-stage amplification circuit 32b. The SAW filter 33 is also provided outside the IC 21. An intermediate frequency signal that is output from the third-stage amplification circuit 32c is input to the first AGC voltage generation circuit 37, which outputs a first AGC voltage. The first AGC voltage corresponds to the level of an input TV signal and is used for controlling the gain of the radio-frequency amplification circuit 12.

The intermediate frequency signal that has been amplified by the intermediate frequency amplification circuit 32 is input to the video detection circuit 34. The video detection circuit 34 is supplied, from the voltage-controlled oscillator 36, with a local oscillation signal, based on which the intermediate frequency signal is synchronously detected and thereby converted into a video signal V. The video signal V is input to a circuit of a TV receiver main body (not shown). The oscillation frequency of the voltage-controlled oscillator 36 is set equal to a video intermediate frequency by an oscillation circuit 36a that is provided outside the IC 21.

An audio intermediate frequency signal of 4.5 MHz that has been extracted by the video detection circuit 34 is FM-detected by the audio detection circuit 35, whereby an audio signal A is extracted. The audio signal A is also input to a circuit of the TV receiver main body.

On the other hand, the video signal V is input to the second AGC voltage generation circuit 38. A second AGC voltage is output from the second AGC voltage generation circuit 38. In the IC 21, the second AGC voltage, which also corresponds to the level of the TV signal, is supplied to the first-stage amplification circuit 32a to the third-stage amplification circuit 32c and is used for controlling their gains.

Therefore, even if the level of the input TV signal becomes too high, distortion that occurs in each of the third-stage amplification circuit 32c and the fourth-stage amplification circuit 32d, which are provided downstream of the second-stage amplification circuit 32b, is kept small.

The IC 21 has a flat package shape that has four side faces 21a-21d. A first side face 21a is provided with a signal input terminal A1 through which to input a TV signal of a selected channel to the mixing circuit 14, a tuning voltage terminal A2 through which to supply the tuning voltage from the PLL circuit section 20 to the input tuning circuit 11, the inter-stage tuning circuit 13, and the resonance circuit 15b, an AGC terminal A3 through which to supply the first AGC voltage to the radio-frequency amplification circuit 12, and other terminals. That is, the first side face 21a is provided with the terminals that are connected to the radio-frequency part of the tuner section 10.

A second side face 21b that is opposed to the first side face 21a is provided with an IF output terminal B1 that is connected to the output end of the first-stage amplification circuit 32a, an IF input terminal B2 that is connected to the input end of the second-stage amplification circuit 32b, and other terminals. By virtue of the above arrangement of terminals, the isolation between the intermediate frequency signal that is obtained by the frequency conversion and the TV signal as a radio-frequency signal that is input to the mixing circuit 14 can be attained.

The third side face 21c is provided with a connection terminal C1 of the resonance circuit 15b and connection terminals C2 and C3 of the intermediate frequency tuning circuit 31. As in the above case, the isolation between the oscillation signal as a radio-frequency signal and the intermediate frequency signal can be attained by providing the connection terminal C1 of the resonance circuit 15b on the side closer to the first side face 21a and providing the connection terminals C2 and C3 of the intermediate frequency tuning circuit 31 on the side closer to the second side face 21b.

The fourth side face 21d is provided with input terminals D1, D2, and D3 for data to be input to the PLL circuit section 20, a connection terminal D4 of the resonance circuit 36a that is connected to the voltage-controlled oscillator 36, an output terminal D5 of the audio signal A, and an output terminal D6 of the video signal V. That is, the fourth side face 21d is provided with the terminals relating to the circuits that handle the signals having lowest frequencies.

As described above, the terminals are assigned to the four side faces 21a-21d of the IC 21 based on the frequencies of the external circuits connected to the respective terminals. This prevents interference between the signals.

A recent tendency is such that the mixing circuit 14 and the oscillation circuit 15 are balanced circuits from the viewpoint of reduction of distortion. Therefore, the use of the IC 21 simplifies the mutual connections very much. This advantage is more remarkable in the case where both of UHF-band TV signals and VHF-band TV signals are to be received.

What is claimed is:

1. A TV tuner unit comprising:
a tuner section for frequency-converting an input TV signal into an intermediate frequency signal, the tuner section comprising:
a mixing circuit for frequency conversion; and
an oscillation circuit for inputting a local oscillation signal to the mixing circuit;
a PLL circuit section for setting a frequency of the local oscillation signal through a tuning voltage by supplying the tuning voltage to the local oscillation circuit; and
a video intermediate frequency circuit section for amplifying and detecting the intermediate frequency signal and thereby outputting a video signal and an audio signal, the video intermediate frequency circuit section comprising an intermediate frequency amplification circuit, a video detection circuit, and an audio detection circuit,
wherein the mixing circuit, an oscillation transistor circuit that is part of the oscillation circuit, the PLL circuit section, the intermediate frequency amplification circuit, the video detection circuit, and the audio detection circuit are provided in a single IC.

2. The TV tuner unit according to claim 1, wherein:
the intermediate frequency amplification circuit includes at least two-stages of cascade-connected amplification circuits;
the TV tuner unit further comprises, outside the IC, a SAW filter that is provided between a first-stage amplification circuit and a second-stage amplification circuit and a resonance circuit that is coupled to the oscillation transistor circuit; and
the IC has a flat package shape having four side faces in which a first side face is provided with a TV signal input terminal through which to input the TV signal to the mixing circuit, a second side face that is opposed to the first side face is provided with an output terminal of the first-stage amplification circuit and an input terminal of the second-stage amplification circuit, a third side face is provided with a resonance circuit connection terminal to which the resonance circuit is connected, and a fourth side face that is opposed to the third side face is provided with an output terminal for the video signal, and output terminal for the audio signal, and a data input terminal through which to input data to be used for setting the tuning voltage to the PLL circuit section.

3. The TV tuner unit according to claim 2, wherein:
the intermediate frequency circuit section comprises an AGC voltage generation circuit for generating an AGC voltage corresponding to a level of the TV signal, the AGC voltage generation circuit being provided in the IC; and
the first-stage amplification circuit and the second-stage amplification circuit of the intermediate frequency amplification circuit are variable gain amplification circuits. having gain control ends, respectively, that are supplied with the AGC voltage.
